(19) United States
(12) Patent Application Publication
(10) Pub. No.: US 2026/0369247 A1
(43) Pub. Date: Nov. 19, 2026

(54) DISPLAY AND CONTROL METHOD THEREOF

(71) Applicant: SAMSUNG ELECTRONICS CO., LTD., Suwon-si (KR)

(72) Inventors: Hyunseok KIM, Suwon-si (KR); Junghyuk KIM, Suwon-si (KR); Kideok SEO, Suwon-si (KR)

(73) Assignee: SAMSUNG ELECTRONICS CO., LTD., Suwon-si (KR)

(21) Appl. No.: 19/725,610

(22) Filed: Jun. 30, 2026

Related U.S. Application Data
(63) Continuation of application No. PCT/KR2024/013427, filed on Sep. 5, 2024.

(30) Foreign Application Priority Data
Jan. 11, 2024 (KR) 10-2024-0005074

(51) Int. Cl. G09G 5/00

(52) U.S. Cl. CPC G09G 5/006; G09G 2340/0435

(57) ABSTRACT

A display includes an image display portions including a panel and at least one processor. The at least one processor is configured to identify a refresh rate section in which a refresh rate of an image signal is included and a set refresh rate corresponding to the refresh rate section; generate a control signal including information about a driving mode corresponding to the set refresh rate; transmit the control signal to the image display portion; convert, using a first refresh rate converter comprised in the one or more processors, the refresh rate of the image signal to match a refresh rate of the panel; and based on the refresh rate of the image signal being included in the refresh rate section, cause the image signal to bypass the first refresh rate converter; convert the image signal into the input signal; and transmit the input signal to the image display portion.

### CROSS-REFERENCE TO RELATED APPLICATIONS

This application is a continuation application of International Patent Application No. PCT/KR2024/013427, filed on Sep. 5, 2024, which claims priority to Korean Patent Application No. 10-2024-0005074, filed on Jan. 11, 2024, in the Korean Intellectual Property Office, the disclosures of which are incorporated herein by reference in their entireties.

### BACKGROUND

### 1. Field

The disclosure relates to a display and a method for controlling the same.

### 2. Description of Related Art

A display may receive signals and output images, text, videos, and the like on a screen based on the signals. Such displays are widely used in electronic devices such as televisions, monitors (e.g., gaming monitors), and tablets.

An image signal having various resolutions and refresh rates may be input to the display. The display may include components such as a scaler and a frame rate controller (FRC) that convert the resolution and the refresh rate of the image signal to match those of a display panel.

The scaler may convert the resolution of the image signal to match the resolution of the panel. The scaler may convert the resolution of the image signal by increasing or decreasing the number of pixels of the image signal.

The FRC may convert the refresh rate (e.g., a frame rate) of the image signal to match the refresh rate of the panel. For example, when the image signal has a refresh rate of 60 Hz and the refresh rate of the panel is 240 Hz, the FRC may convert 60 Hz of the image signal into 240 Hz of the panel.

However, there may be increased power consumption due to the FRC utilizing computing resources such as a double data rate (DDR) memory and a flash memory during frame rate conversion. Also, when the refresh rate of the image signal is adjusted by the FRC to match the refresh rate of the panel, a delay (e.g., latency while processing an input or a signal) may be caused. Power consumption and processing delays can be improved while converting the refresh rate of the image signal to match the refresh rate of the panel.

Information disclosed in this Background section was either known to the inventors before achieving the present disclosure or represents technical information acquired during the development process. Therefore, it may contain information that does not constitute prior art known to the public.

### SUMMARY

Provided is a display that may efficiently process an image signal and output the image signal to a panel.

According to an aspect of the disclosure, a display may include an image display portion comprising a panel, and at least one processor configured to identify a refresh rate section in which a refresh rate of an image signal is included and a set refresh rate corresponding to the refresh rate section; generate a control signal including information about a driving mode corresponding to the set refresh rate; transmit the control signal to the image display portion; convert a resolution of the image signal to match a resolution of the panel; convert, using a first refresh rate converter comprised in the one or more processors, the refresh rate of the image signal to match a refresh rate of the panel; and based on the refresh rate of the image signal being included in the refresh rate section, cause the image signal to bypass the first refresh rate converter; convert the image signal into the input signal; and transmit the input signal to the image display portion. Based on receiving the input signal, the image display portion may be configured to drive the driving mode based on the control signal to output the image signal to the panel.

According to an aspect of the disclosure, a method for controlling a display may include identifying a refresh rate section in which a refresh rate of an image signal is included, and a set refresh rate corresponding to the refresh rate section; generating a control signal including information about a driving mode corresponding to the set refresh rate; transmitting the control signal to an image display portion; converting a resolution of the image signal to match a resolution of a panel; based on bypassing a first refresh rate converter configured to convert the refresh rate of the image signal to match a refresh rate of the panel, converting the converted image signal into an input signal of the panel; and transmitting the input signal to the image display portion; and driving, by the image display portion, the driving mode based on the control signal to output the image signal to the panel.

One or more embodiments of the present disclosure may provide improvements in computer technology or technical field. For example, display devices may efficiently process an image signal and output the image signal to a panel. Also, energy efficiency may be improved by reducing power consumption through decreased resource utilization. Moreover, user experience may be improved by supporting low input lag in an environment where real-time interaction is critical.

The technical improvements that may be provided by one or more embodiments of the present disclosure are not limited to the above-mentioned effects, and other effects not mentioned will be clearly understood by one of ordinary skill in the technical art to which the disclosure belongs from the following description.

The above-described summary is provided to introduce, in a simplified format, a selection of the disclosure that is further described in the detailed description. This summary is neither intended to identify key or essential aspects of the disclosure nor to determine the scope of the disclosure.

### DESCRIPTION OF DRAWINGS

The above and other aspects, features, and advantages of one or more embodiments of the present disclosure will be more apparent from the following description taken in conjunction with the accompanying drawings, in which:

FIG. 1 is a block diagram of a display according to an embodiment;

FIG. 2 illustrates preset refresh rate sections and respective refresh rates set to correspond to each refresh rate section according to an embodiment;

FIG. 3 illustrates generation of a control signal including information about a driving mode corresponding to a set refresh rate and transmission of the control signal to an image display portion according to an embodiment;

FIG. 4 illustrates operation of a display in a case where a refresh rate of an image signal is included in a refresh rate section according to an embodiment;

FIG. 5 illustrates operation of a display in a case where a refresh rate of an image signal is not included in a refresh rate section according to an embodiment; and

FIG. 6 is a flowchart illustrating a method for controlling a display according to an embodiment.

### DETAILED DESCRIPTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Unless stated otherwise or otherwise clear from context, phrase “based on” may refer to “based at least in part on” and not “based solely on.”

Terms such as “portion”, “module”, and “member” may be embodied as hardware (e.g., processor 120) or software (e.g., instructions, computer code). According to embodiments, a plurality of “portion”, “module”, and “member” may be implemented as a single component or a single “portion”, “module”, and “member” may include a plurality of components.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

One or more embodiments of the present disclosure will be described in detail with reference to the accompanying drawings. Specific configurations and details are provided to ensure thorough understanding of the implementation techniques. However, these techniques may be practiced in different configurations without such specifics. Well-known features may be omitted or simplified to avoid obscuring the described techniques.

Recitation of ranges of values is merely intended to serve as a shorthand method of referring individually to each separate value falling within the range, unless otherwise indicated. Each separate value is incorporated into the present disclosure as if it were individually recited. Also, numerical values are understood to include values that are close to or approximately equal to the stated value, unless otherwise specified. For example, a value of 200 encompasses about or approximately 200 or values close to 200.

The embodiments described herein are non-limiting example embodiments, and thus, the disclosure is not limited thereto and may be realized in various other forms. One or more features of at least one embodiment provided herein may be applied to one or more other embodiments provided herein or not provided but consistent with the disclosure. Also, at least one embodiment provided herein is not excluded from being associated with one or more features of another example or another embodiment also provided herein or not provided herein but consistent with the disclosure.

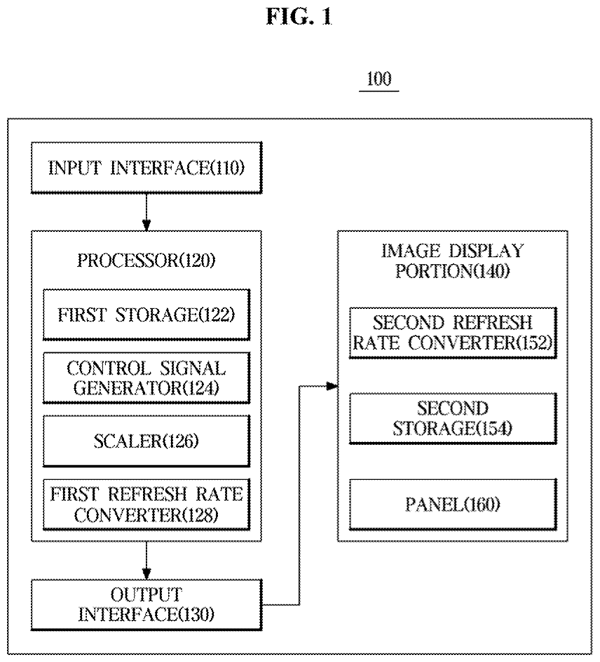

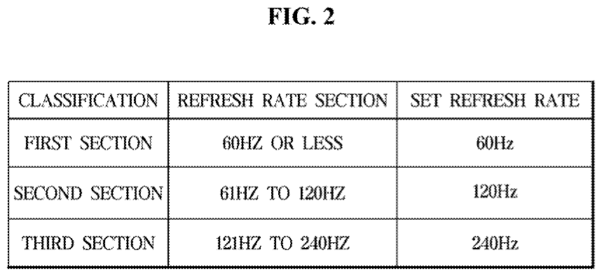

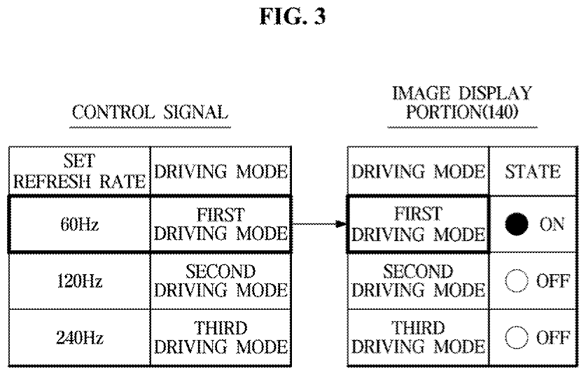

FIG. 1 is a block diagram of a display according to an embodiment. FIG. 2 illustrates preset refresh rate sections and respective refresh rates set to correspond to each refresh rate section according to an embodiment. FIG. 3 illustrates generation of a control signal including information about a driving mode corresponding to a set refresh rate, and transmission of the control signal to an image display portion according to an embodiment.

Referring to FIG. 1, a display 100 may include an input interface 110, at least one processor 120 (hereafter referred to as “the processor”), an output interface 130, and an image display portion 140. The display 100 may be used in various electronic devices such as televisions, monitors, and tablets. Hereinafter, for ease of understanding, the display 100 for ultra high definition (UHD) 240 Hz monitor will be described as an example.

The input interface 110 may receive an image signal from a source device through, for example, a high-definition multimedia interface (HDMI), a display port (DP), or the like. The source device may include, for example, a computer graphics card, a game console, a media player, and the like.

The processor 120 may process an image signal received via the input interface 110, and may convert the image signal into an input signal that may be recognized by (e.g., compatible with) the panel 160.

The processor 120 may include a first storage 122, a control signal generator 124, a scaler 126, and a first refresh rate converter 128.

The processor 120 may control overall operations and functions of the display 100, and may include a memory. All functions of the display 100 may be processed by a single processor 120 or performed by a combination of the processors 120.

The processor 120 may be implemented as a digital signal processor (DSP) or a microprocessor. However, embodiments of the disclosure are not limited thereto, and the processor 120 may include at least one of a central processing unit (CPU), a micro controller unit (MCU), a micro processing unit (MPU), a controller, a graphics processing unit (GPU), an application processor (AP), a communication processor (CP), or an ARM processor, or may be defined by a corresponding term. In addition, the processor 120 may be implemented in the form of a system on chip (SoC), a large scale integration (LSI), application-specific integrated circuit (ASIC), or a field programmable gate array (FPGA) in which a processing algorithm is embedded.

The processor 120 may include a logic circuit and an arithmetic circuit in hardware. The processor 120 may control electrically connected components of the display 100 using programs, instructions, and/or data stored in the memory for operation of the display 100. The processor 120 and the memory may be implemented as separate chips or as a single chip.

The memory may store programs, applications, and/or data for operation of the display 100, and may store data generated by the processor. The memory may include a non-volatile memory such as a read only memory (ROM) or a flash memory for long-term data storage. The memory may include a volatile memory such as a static random access memory (S-RAM) or a dynamic random access memory (D-RAM) for temporarily storing data. The memory may be included in the first storage 122.

Referring to FIG. 2, the first storage 122 may store a preset refresh rate section and a set refresh rate corresponding to the refresh rate section.

For example, the refresh rate section may be divided into a first section of 60 Hz or less, a second section of 61 Hz to 120 Hz, and a third section of 121 Hz to 240 Hz. However, the disclosure is not limited thereto, and the refresh rate section may be divided differently in other embodiments.

The set refresh rate corresponding to the first section may be 60 Hz, the set refresh rate corresponding to the second section may be 120 Hz, and the set refresh rate corresponding to the third section may be 240 Hz.

The control signal generator 124 may identify a refresh rate section in which a refresh rate of an image signal is included (within which a refresh rate of an image signal falls) and a corresponding set refresh rate, may generate a control signal including information about a driving mode corresponding to the set refresh rate, and may transmit the control signal to the image display portion 140.

For example, in a case where a refresh rate of an image signal is 60 Hz, the refresh rate may fall within the first section, and a set refresh rate corresponding to the first section may be 60 Hz.

Referring to FIG. 3, in this case, the control signal generator 124 may generate a control signal including information about a first driving mode corresponding to the set refresh rate of 60 Hz, and may transmit the control signal to the image display portion 140. Information about the first to third driving modes corresponding to set refresh rates of respective first to third sections may be stored in the image display portion 140.

Based on receiving the control signal described above, the image display portion 140 may recognize the information about the first driving mode included in the control signal, and may change a state of the first driving mode from among the first to third driving modes stored in the image display portion 140 side to an active state. The second and third driving modes may be maintained in an inactive state. Through the above, the image display portion 140 may prepare to drive the first driving mode.

In a case where a set refresh rate is 120 Hz, a control signal including information about the second driving mode may be transmitted to the image display portion 140. Based on receiving the corresponding control signal, the image display portion 140 may recognize the second driving mode included in the control signal, and may change a state of the second driving mode from among the driving modes stored in the image display portion 140 side to an active state. The first and third driving modes may be maintained in an inactive state.

In a case where a set refresh rate is 240 Hz, a control signal including information about the third driving mode may be transmitted to the image display portion 140. Based on receiving the corresponding control signal, the image display portion 140 may recognize the third driving mode included in the control signal, and may change a state of the third driving mode from among the driving modes stored in the image display portion 140 side to an active state. The first and second driving modes may be maintained in an inactive state.

The scaler 126 may convert a resolution of the image signal to match a resolution of the panel 160. For example, the scaler 126 may convert a full high definition (FHD) resolution of the image signal to match an ultra high definition (UHD) resolution of the panel 160. The FHD resolution is 1920×1080 pixels, and the resolution includes 1920 pixels in a horizontal direction and 1080 pixels in a vertical direction. The UHD resolution may be 3840×2160 pixels or 4096×2160 pixels.

For example, the scaler 126 may convert the resolution of the image signal to match the resolution of the panel 160 by increasing or decreasing the number of pixels of the image signal based on a preset pixel size value of the panel 160.

In another embodiment, the scaler 126 may be configured separately from the processor 120. In this case, the processor 120 may control the scaler 126 to convert the resolution of the image signal to match the resolution of the panel 160.

The first refresh rate converter 128 may convert a refresh rate of an image signal to match a refresh rate of the panel 160.

For example, in a case where an image signal has a refresh rate of 60 Hz and a refresh rate of the panel is 240 Hz, the first refresh rate converter 128 may convert the refresh rate of the image signal from 60 Hz to 240 Hz. In this instance, the first refresh rate converter 128 may convert the refresh rate of the image signal to match the refresh rate of the panel 160 by generating a new frame.

The first refresh rate converter 128 may include a frame rate controller (FRC).

The first refresh rate converter 128 may use resources such as a double data rate (DDR) memory and a flash memory during the refresh rate conversion.

In a case where a refresh rate of an image signal is included in the above-described refresh rate section, the processor 120 may cause the image signal to bypass the first refresh rate converter 128 after the image signal passes through the scaler 126, may convert the image signal into the input signal compatible with the panel 160, and may transmit the input signal to the image display portion 140 through the output interface 130. For example, the processor 120 may analyze various pieces of information included in the image signal and convert the image signal into a signal receivable by the panel 160. The input signal may include information such as a resolution and a refresh rate of the image signal, color data to be displayed on each pixel of the panel 160, high dynamic range (HDR), and Freesync. Here, HDR improves contrast between bright and dark regions to provide a more natural image. Freesync synchronizes pixel output between a graphics card and the display to reduce or eliminate screen tearing and stutter.

As described above, the first refresh rate converter 128 uses resources such as a DDR memory and a flash memory, resulting in increased power consumption. In some examples, in a use case requiring real-time interaction, such as gaming, low input lag is critical. When a refresh rate of an image signal is adjusted to match a refresh rate of the panel 160 by the first refresh rate converter 128, a timing delay (e.g., latency) may occur. In a gaming environment where low input lag is critical, such a timing delay may result in failure to support low input lag for a gaming monitor.

In an embodiment of the disclosure, in a case where a refresh rate of an image signal is included in the above-described refresh rate section, the processor 120 may cause the image signal to bypass the first refresh rate converter 128 after the image signal passes through the scaler 126.

For example, in a case where an image signal has a refresh rate of 60.4 Hz which falls within the first section among the above-described refresh rate sections, the image signal converted by the scaler 126 to match the resolution of the panel 160 bypasses the first refresh rate converter 128. Thereafter, the image signal may be converted into an input signal compatible with the panel 160 and be transmitted to the image display portion 140.

In some examples, input lag caused by the timing delay may be reduced. In a case where the image signal bypasses the first refresh rate converter 128, power supplied to the first refresh rate converter 128 is turned off, and thus the first refresh rate converter 128 may be converted to an inactive state.

In a case where a refresh rate of an image signal is not included in the above-described refresh rate section, the processor 120 may convert a resolution of the image signal to match a resolution of the panel 160 using the scaler 126, and may convert the refresh rate of the image signal to match the refresh rate of the panel 160 using the first refresh rate converter 128.

For example, the above-described refresh rate section may be divided into the first section of 60 Hz or less, the second section of 120 Hz, and the third section of 240 Hz, and the set refresh rate corresponding to the first section is 60 Hz, the set refresh rate corresponding to the second section is 120 Hz, and the set refresh rate corresponding to the third section is 240 Hz.

In this instance, in a case where an image signal of 144 Hz is input, a refresh rate of the image signal may not be included in any of the first to third sections.

In this case, the processor 120 may convert a full high definition (FHD) resolution of the image signal to match an ultra high definition (UHD) resolution of the panel 160 using the scaler 126 and convert the refresh rate (144 Hz) of the image signal to match the refresh rate (240 Hz) of the panel 160 using the first refresh rate converter 128.

For example, in the case of a gaming monitor, providing a high-quality image by converting the refresh rate of the image signal to match the refresh rate of the panel 160 using the first refresh rate converter 128 may be more critical than reducing input lag or power consumption.

In a case where an image signal having a refresh rate of 144 Hz is input, the refresh rate may exceed the refresh rate (120 Hz) of the second section and is lower than the refresh rate (240 Hz) of the third section. In some examples, a control signal may include information about the third driving mode and may be transmitted to the image display portion 140. The image display portion 140 may be prepared for driving by activating the third driving mode based on the control signal.

The output interface 130 may transmit the input signal compatible with the panel 160 to the image display portion 140.

The image display portion 140 may adjust a timing at which each pixel is activated when displaying the image signal on the panel 160, such that the pixels are activated in a correct order to generate an accurate image.

The image display portion 140 may control a color and brightness of each pixel The image display portion 140 may assign a value to each pixel based on color and contrast information of the image signal to reproduce the accurate color and contrast.

In response to receiving the input signal, the image display portion 140 may drive a driving mode in an active state based on the control signal to output the image signal to the panel 160.

For example, in a 240 Hz UHD monitor environment, at least one of sharpness or color coordinates may be adjusted according to each driving mode corresponding to the above-described set refresh rate.

For example, when the first driving mode is driven, a sharpness value may be emphasized. When the second driving mode is driven, an afterimage or flicker may occur, and thus the sharpness value may be reduced and color coordinate tuning may be performed to prevent flicker.

The image display portion 140 may include a second refresh rate converter 152, a second storage 154, and the panel 160.

In a case where a refresh rate of an image signal included in an input signal is included in the refresh rate section, the second refresh rate converter 152 may convert the refresh rate of the image signal included in the input signal into the set refresh rate corresponding to the refresh rate section within which the refresh rate of the image signal falls. The second refresh rate converter 152 may include a frame rate controller (FRC).

The image display portion 140 may be designed to match characteristics of the panel 160 and may quickly process a refresh rate conversion through high-performance processing. In some examples, even when the second refresh rate converter 152 may convert the refresh rate of the image signal included in the input signal into the set refresh rate corresponding to the refresh rate section within which the refresh rate of the image signal falls, a timing delay may be prevented.

For example, it is assumed that the refresh rate section may be divided into the first section of 60 Hz or less, the second section of 61 Hz to 120 Hz, and the third section of 121 Hz to 240 Hz, and the set refresh rate corresponding to the first section is 60 Hz, the set refresh rate corresponding to the second section may be 120 Hz, and the set refresh rate corresponding to the third section may be 240 Hz.

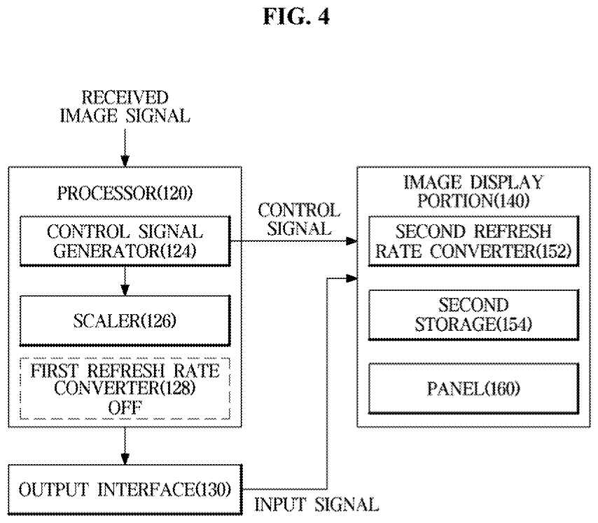

FIG. 4 illustrates operation of a display in a case where a refresh rate of an image signal is included in a refresh rate section according to an embodiment.

Referring to FIG. 4, as described above, in a case where an image signal has a refresh rate of 60.4 Hz, the image signal is converted by the scaler 126 to match the UHD resolution of the panel 160, and after bypassing the first refresh rate converter 128, the image signal may be converted into an input signal and input to the image display portion 140 through the output interface 130.

In this instance, because a control signal for activating the first driving mode is transmitted to the image display portion 140, in response to receiving the input signal, the image display portion 140 may convert the refresh rate (60.4 Hz) of the image signal into the set refresh rate (60 Hz) corresponding to the first section using the second refresh rate converter 152, and may drive the first driving mode.

In a case where a refresh rate of an image signal is not included in the refresh rate section, the image display portion 140 may cause an input signal to bypass the second refresh rate converter 152.

For example, the refresh rate section may be divided into the first section of 60 Hz or less, the second section of 120 Hz, and the third section of 240 Hz, and the set refresh rate corresponding to the first section is 60 Hz, the set refresh rate corresponding to the second section may be 120 Hz, and the set refresh rate corresponding to the third section may be 240 Hz.

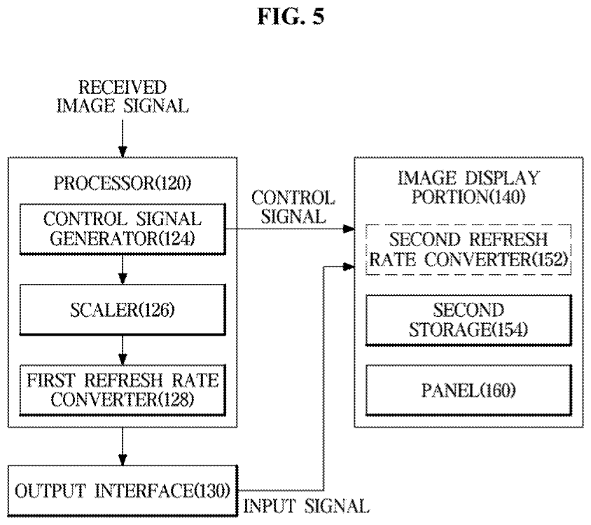

FIG. 5 illustrates operation of a display in a case where a refresh rate of an image signal is not included in a refresh rate section according to an embodiment.

Referring to FIG. 5, in a case where an image signal has a refresh rate of 144 Hz, the refresh rate of the image signal may not be included in any of the first to third sections.

The image signal may be converted by the scaler 126 to match the UHD resolution of the panel 160, and after being converted into the refresh rate (240 Hz) of the panel 160 by the first refresh rate converter 128, the image signal may be input to the image display portion 140 as an input signal through the output interface 130.

In a case where the refresh rate of the image signal is 144 Hz, as described above, because a control signal for activating the third driving mode is transmitted to the image display portion 140, the image display portion 140 may drive the third driving mode in a state in which the input signal bypasses the second refresh rate converter 152.

The second storage 154 may store information about the first to third sections, information about the refresh rate set for each section, information about a plurality of driving modes corresponding to each set refresh rate, state information of each driving mode, and the like. In some examples, the second storage 154 may store color coordinates, values of a color gamut, and the like related to each driving mode. The second storage 154 may store programs, applications, and/or data for operation of the image display portion 140, and may store data generated by the image display portion 140. The second storage 154 may include a non-volatile memory such as a read only memory (ROM) or a flash memory for long-term data storage. The second storage 154 may include a volatile memory such as a static random access memory (S-RAM) or dynamic random access memory (D-RAM) for temporarily storing data.

Some of the operations and functions of the image display portion 140 may be performed by a timing controller (TCon), and the timing controller may be included in the image display portion 140 or provided on a separate main board. In this case, the image display portion 140 may perform some of the operations and functions of the image display portion 140 by controlling the timing controller.

The panel 160 may be a part of the display 100, and may activate pixels and display accurate colors based on the signals generated by the image display portion 140.

The panel 160 may include, for example, twisted nematic (TN), in-plane switching (IPS), vertical alignment (VA), organic light-emitting diode (OLED), microLED, quantum dot LED (QLED), and the like. Inside the panel 160, a driving circuit, a backlight unit, and the like that may be implemented in a form such as an a-Si TFT, a low temperature poly silicon (LTPS) TFT, an organic TFT (OTFT), and the like may be included.

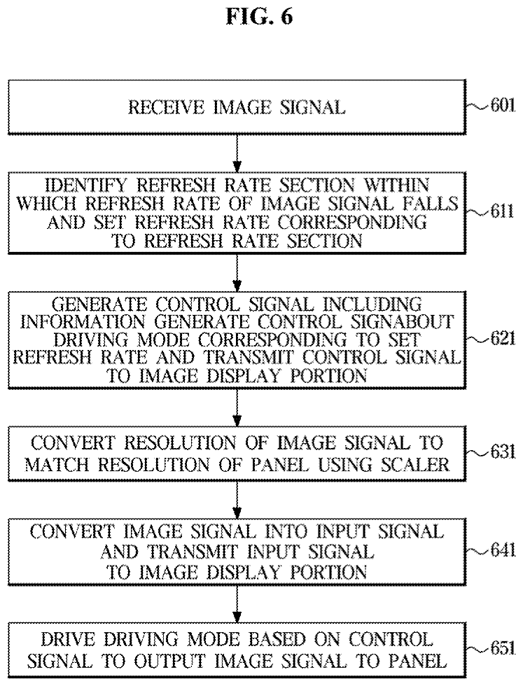

FIG. 6 is a flowchart illustrating a method for controlling a display according to an embodiment. Hereinafter, redundant descriptions will be omitted. Operations illustrated in FIG. 6 may be performed sequentially, in a different order, in parallel, or with some operations skipped or repeated.

Referring to FIG. 6, an image signal may be received by the input interface 110 (601). For example, the display 100 of a UHD 240 Hz monitor may receive an image signal of FHD 60.4 Hz.

The processor 120 may identify a refresh rate section within which a refresh rate of the image signal falls and a set refresh rate corresponding to the refresh rate section using the control signal generator 124, may generate a control signal including information about the driving mode corresponding to the set refresh rate, and may transmit the control signal to the image display portion 140 (611, 621).

For example, the refresh rate section may be divided into the first section of 60 Hz or less, the second section of 61 Hz to 120 Hz, and the third section of 121 Hz to 240 Hz, and the set refresh rate corresponding to the first section is 60 Hz, the set refresh rate corresponding to the second section may be 120 Hz, and the set refresh rate corresponding to the third section may be 240 Hz. The control signal generator 124 may identify the first section within which the refresh rate of the image signal falls and the set refresh rate (60 Hz) corresponding to the first section, generate a control signal including information about the first driving mode corresponding to the set refresh rate, and transmit the control signal to the image display portion 140.

A resolution of the image signal may be converted by the scaler 126 to match a resolution of the panel 160 (631). The scaler 126 may convert FHD resolution of the image signal into UHD resolution of the panel 160.

In a state of bypassing the first refresh rate converter 128 that converts the refresh rate of the image signal to match the refresh rate of the panel 160, the processor 120 may convert the image signal converted by the scaler 126 into an input signal compatible with the panel 160, and transmit the input signal to the image display portion 140 through the output interface 130 (641).

In another example, in a case where a refresh rate of an image signal is not included in the refresh rate section, a process of converting the refresh rate of the image signal, converted to match the resolution of the panel 160 using the scaler 126, to match the refresh rate of the panel using the first refresh rate converter 128 may be further included.

In response to receiving the input signal, the image display portion 140 may drive the driving mode based on the control signal to output the image signal to the panel 160 (651).

In some examples, the image display portion 140 may convert the refresh rate of the image signal included in the input signal into the set refresh rate corresponding to the refresh rate section within which the refresh rate of the image signal falls using the second refresh rate converter 152.

For example, the image display portion 140 may convert the refresh rate (60.4 Hz) of the image signal into the set refresh rate (60 Hz) corresponding to the first section within which the refresh rate of the image signal falls using the second refresh rate converter 152. In another example, in a case where an image signal has a refresh rate of 144 Hz, the image display portion 140 may convert the refresh rate into the set refresh rate (240 Hz) corresponding to the third section within which the refresh rate of the image signal falls.

As described above, in a case where the refresh rate of the image signal is not included in the refresh rate section, the image display portion 140 may process the input signal to bypass the second refresh rate converter 152.

The method according to the various embodiments disclosed herein may be provided in a computer program product. The computer program product may be traded between a seller and a buyer as a product. The computer program product may be distributed in the form of a machine-readable recording medium (e.g., compact disc read only memory (CD-ROM)), or may be distributed (e.g., download or upload) through an application store (e.g., Play Store™) online or directly between two user devices (e.g., smartphones). In the case of online distribution, at least a portion of the computer program product (e.g., downloadable app) may be stored at least semi-permanently or may be temporarily generated in a recording medium, such as a memory of a server of a manufacturer, a server of an application store, or a relay server.

According to one or more embodiments of the present disclosure, a display may include an image display portion comprising a panel, and one or more processors. The one or more processors may be configured to identify a refresh rate section in which a refresh rate of an image signal is included and a set refresh rate corresponding to the refresh rate section; generate a control signal including information about a driving mode corresponding to the set refresh rate; transmit the control signal to the image display portion; convert a resolution of the image signal to match a resolution of the panel; convert, using a first refresh rate converter comprised in the one or more processors, the refresh rate of the image signal to match a refresh rate of the panel; and based on the refresh rate of the image signal being included in the refresh rate section, cause the image signal to bypass the first refresh rate converter; convert the image signal into the input signal; and transmit the input signal to the image display portion. Based on receiving the input signal, the image display portion may be configured to drive the driving mode based on the control signal to output the image signal to the panel.

Based on the refresh rate of the image signal not being included in the refresh rate section, the one or more processors may be further configured to, convert the resolution of the image signal to match the resolution of the panel; and convert, using the first refresh rate converter, the refresh rate of the image signal to match the refresh rate of the panel.

The image display portion may include a second refresh rate converter configured to, convert the refresh rate of the image signal included in the input signal into the set refresh rate corresponding to the refresh rate section in which the refresh rate of the image signal is included, based on the refresh rate of the image signal being included in the refresh rate section.

The image display portion may be further configured to cause the input signal t bypass the second refresh rate converter, based on the refresh rate of the image signal not being included in the refresh rate section.

The refresh rate section may be divided into, a first section of 60 Hz or less; a second section of 61 Hz to 120 Hz; and a third section of 121 Hz to 240 Hz.

The set refresh rate corresponding to the first section may be 60 Hz. The set refresh rate corresponding to the second section may be 120 Hz.

The image display portion may include a second storage configured to store information about a plurality of driving modes corresponding to respective refresh rate set for the first section, the second section, and the third section.

The image display portion may be configured to adjust at least one of color sharpness or color coordinates based on the driving mode.

According to one or more embodiments of the present disclosure, a method for controlling a display may include identifying a refresh rate section in which a refresh rate of an image signal is included, and a set refresh rate corresponding to the refresh rate section; generating a control signal including information about a driving mode corresponding to the set refresh rate; transmitting the control signal to an image display portion; converting a resolution of the image signal to match a resolution of a panel; based on bypassing a first refresh rate converter configured to convert the refresh rate of the image signal to match a refresh rate of the panel, converting the converted image signal into an input signal of the panel; and transmitting the input signal to the image display portion; and driving, by the image display portion, the driving mode based on the control signal to output the image signal to the panel.

The method may further include based on the refresh rate of the image signal not being included in the refresh rate section, converting, by the first refresh rate converter, the refresh rate of the image signal to match the refresh rate of the panel.

The method may further include, based on the refresh rate of the image signal being included in the refresh rate section, converting, by a second refresh rate converter of the image display portion, the refresh rate of the image signal included in the input signal into the set refresh rate corresponding to the refresh rate section in which the refresh rate of the image signal is included.

The method may further include, based on the refresh rate of the image signal not being included in the refresh rate section, processing, by the image display portion, the input signal to bypass the second refresh rate converter.

The refresh rate section may be divided into, a first section of 60 Hz or less; a second section of 61 Hz to 120 Hz; and a third section of 121 Hz to 240 Hz.

The method may further include, adjusting, by the image display portion, at least one of color sharpness or color coordinates based on the driving mode.

The set refresh rate corresponding to the first section may be 60 Hz. The set refresh rate corresponding to the second section may be 120 Hz.

Although embodiments of the disclosure have been described with reference to the accompanying drawings, a person having ordinary skilled in the art will appreciate that modifications may be made without departing from the technical spirit or essential features of the disclosure. Therefore, the foregoing embodiments should be regarded as illustrative rather than limiting in all aspects.

What is claimed is:

1. A display, comprising:
an image display portion comprising a panel; and
at least one processor configured to:
identify a refresh rate section in which a refresh rate of an image signal is included and a set refresh rate corresponding to the refresh rate section;
generate a control signal including information about a driving mode corresponding to the set refresh rate;
transmit the control signal to the image display portion;
convert a resolution of the image signal to match a resolution of the panel; and
convert, using a first refresh rate converter comprised in the at least one processor, the refresh rate of the image signal to match a refresh rate of the panel; and
based on the refresh rate of the image signal being included in the refresh rate section:
cause the image signal to bypass the first refresh rate converter;
convert the image signal into an input signal; and
transmit the input signal to the image display portion,
wherein, based on receiving the input signal, the image display portion is configured to drive the driving mode based on the control signal to output the image signal to the panel.

2. The display of claim 1, wherein, based on the refresh rate of the image signal not being included in the refresh rate section, the at least one processor is further configured to:
convert the resolution of the image signal to match the resolution of the panel; and
convert, using the first refresh rate converter, the refresh rate of the image signal to match the refresh rate of the panel.

3. The display of claim 1, wherein the image display portion comprises a second refresh rate converter configured to convert the refresh rate of the image signal included in the input signal into the set refresh rate corresponding to the refresh rate section in which the refresh rate of the image signal is included, based on the refresh rate of the image signal being included in the refresh rate section.

4. The display of claim 3, wherein the image display portion is further configured to cause the input signal to bypass the second refresh rate converter, based on the refresh rate of the image signal not being included in the refresh rate section.

5. The display of claim 1, wherein the refresh rate section is divided into:
a first section of 60 Hz or less, a second section of 61 Hz to 120 Hz, and a third section of 121 Hz to 240 Hz.

6. The display of claim 5, wherein the set refresh rate corresponding to the first section is 60 Hz,
wherein the set refresh rate corresponding to the second section is 120 Hz, and
wherein the set refresh rate corresponding to the third section is 240 Hz.

7. The display of claim 6, wherein the image display portion comprises a second storage configured to store information about a plurality of driving modes corresponding to respective refresh rate set for the first section, the second section, and the third section.

8. The display of claim 7, wherein the image display portion is configured to adjust at least one of color sharpness or color coordinates based on the driving mode.

9. A method for controlling a display, comprising:
identifying a refresh rate section in which a refresh rate of an image signal is included, and a set refresh rate corresponding to the refresh rate section;
generating a control signal including information about a driving mode corresponding to the set refresh rate;
transmitting the control signal to an image display portion;
converting a resolution of the image signal to match a resolution of a panel;
based on bypassing a first refresh rate converter configured to convert the refresh rate of the image signal to match a refresh rate of the panel:
converting the converted image signal into an input signal of the panel; and
transmitting the input signal to the image display portion; and
driving, by the image display portion, the driving mode based on the control signal to output the image signal to the panel.

10. The method of claim 9, further comprising:
based on the refresh rate of the image signal not being included in the refresh rate section,
converting, by the first refresh rate converter, the refresh rate of the image signal to match the refresh rate of the panel.

11. The method of claim 9, further comprising:
based on the refresh rate of the image signal being included in the refresh rate section, converting, by a second refresh rate converter of the image display portion, the refresh rate of the image signal included in the input signal into the set refresh rate corresponding to the refresh rate section in which the refresh rate of the image signal is included.

12. The method of claim 11, further comprising:
based on the refresh rate of the image signal not being included in the refresh rate section, processing, by the image display portion, the input signal to bypass the second refresh rate converter.

13. The method of claim 9, wherein the refresh rate section is divided into:
a first section of 60 Hz or less;
a second section of 61 Hz to 120 Hz; and
a third section of 121 Hz to 240 Hz.

14. The method of claim 9, further comprising:
adjusting, by the image display portion, at least one of color sharpness or color coordinates based on the driving mode.

15. The method of claim 13, wherein the set refresh rate corresponding to the first section is 60 Hz,
the set refresh rate corresponding to the second section is 120 Hz, and
the set refresh rate corresponding to the third section is 240 Hz.
